(19) United States
(12) Patent Application Publication
(10) Pub. No.: US 2007/0210041 A1
(43) Pub. Date: Sep. 13, 2007

(54) Automatic focusing of electron beams using a modified Faraday cup diagnostic

(75) Inventors: John W. Elmer, Danville, CA (US); Todd A. Palmer, Livermore, CA (US); Alan T. Teruya, Livermore, CA (US)

Correspondence Address: Michael C. Staggs;Attorney for Applicants, Lawrence Livermore National Laboratory, P.O. Box 808, L-703, Livermore, CA, 94551, US

(73) Assignee: The Regents of the University of California

(21) Appl. No.: 11/367,846

(22) Filed: Mar. 2, 2006

(51) Int. Cl. B23K 26/00; H01J 3/14

(52) U.S. Cl. 219/121.64; 250/398; 250/492.3

(57) ABSTRACT

The present invention relates to a method and system for automatically focusing an electron beam. Such an invention is based on a Faraday Cup diagnostic system, often a Modified Faraday Cup (MFC) system that enables tomographic reconstruction of the beam so as to measure beam parameters. Such a reconstruction method and system is automated using a servo-feedback loop to determine, for example, power distributions of the beam so as to provide appropriate adjustments to system controls to enable desired beam focus conditions.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

1. Field of the Invention

The present invention relates to beam focusing, and more particularly to an automatic method for determining a desired beam focus condition for electron beams in an electron beam welder.

2. State of Technology

A number of factors affect the “sharp focus” condition of an electron beam: beam current; beam voltage; filament current; focus coil current; travel speed; distance from the electron gun to the workpiece; chamber vacuum level; etc. Of these parameters, the determination of the focus coil current setting which corresponds to the “sharp focus” condition of the beam is the most difficult to define and reproduce on a consistent basis.

Typically, focusing of an electron beam in an electron beam welding machine is a manual operation performed by an operator directing the beam onto a consumable tungsten block, under the conditions to be used during welding. The operator observes the brightness of a spot heated by the beam and adjusts the focus coil current until the spot is at its brightest, which is then assumed to be the “sharp focus” setting. Such a procedure is highly speculative because it depends on the operator's judgment to interpret visible light emission from the locally heated target block. Thus subjectivity can result in variations in the “sharp focus” setting between different operators. Accuracy in the choice of the “sharp focus” setting may also be degraded by slow changes in the brightness of the spot with changes in the focus current coil setting, or by the electron beam damaging the tungsten target. In addition, such a rudimentary focusing method only allows the operator to adjust a beam close to sharp focus and does not allow the beam to be reliably defocused by a known amount in order to produce a beam of greater width and lower power density. Moreover, visual-manual determination is generally satisfactory at lower current levels, but becomes difficult to apply at higher levels, e.g., currents above 10 mA.

Background information for systems and methods of profiling power distributions within an electron beam can be found in WO 01/51183, Japanese Patents No. 11,154,489 and No. 9,166,698, in addition to U.S. Pat. No. 5,198,676, No. 6,300,755, No. 5,468,966, No. 5,554,926, No. 5,382,895 and No. 5,583,427. Further background information on such diagnostic methods and devices is described by J. W. Elmer et al. in, “Tomographic Imaging of Non-Circular and Irregular Electron Beam Power Density Distributions,” Welding Journal 72 (ii), p. 493-s, 1993; A. T. Teruya et al.; “Fast Method for measuring power-density distribution of non-circular and irregular electron beams,” Science and Technology of Welding and Joining, 3(2):51 Elmer, J. W. and Teruya A. T.; “An Enhanced Faraday Cup for Rapid Determination of Power Density Distribution in Electron Beams,” Welding Journal 80(12), pp. 288-s to 295-s, Elmer, J. W. and Teruya A. T.

Background information on an automatic focusing method of an electron beam is described in U.S. Pat. No. 5,483,036, including the following: “An automated procedure changes the focus coil current until the focal point location is just below a workpiece surface. A parabolic equation is fitted to the calculated beam sizes from which optimal focus coil current and optimal beam diameter are determined.”

Accordingly, there is a need for an improved automatic and quantitative method and system for focusing electron beams. The present invention is directed to such a need.

### SUMMARY OF THE INVENTION

Accordingly, the present invention provides an automatic method to provide a desired focus for a beam that often includes: setting an arbitrary sharp focus coil current, providing a feedback loop so as to provide automatically, a predetermined plurality of focus coil current increments positively above and negatively below the arbitrary sharp focus coil current, tomographically reconstructing a plurality of beams resulting from a plurality of received Faraday cup measurements, wherein each of the beams correlate to a respective focus coil current; calculating Peak Power Densities and a corresponding locus of beam diameters resulting from respective tomographically reconstructed beams; and determining a desired focus coil current based on respective calculated beam diameters so as to provide a desired beam focus condition for a predetermined application.

A further aspect of the present invention provides a method for providing a desired beam focus condition for an electron beam welder to include: setting a predetermined focus coil current; sweeping a beam across a disk having a plurality of slits, the disk being arranged in a Faraday cup system, positioning a probe to detect secondary and backscattered electrons from a predetermined position on the disk; sensing a signal produced by the probe; calculating the proper orientation of the beam based on the signal so as to produce a set of beam profile data; and processing the beam profile data so as to tomographically reconstruct the power distribution in the beam; calculating a beam diameter resulting from the tomographically reconstructed beam; providing a predetermined incremental focus coil current; iterating the steps described above until a desired locus of Peak Power Densities and beam diameters are computed; and setting a desired focus coil current based on calculated beam diameters to provide a desired beam focus condition for a given application.

Another aspect of the present invention provides a system having a feedback loop means coupled to a predetermined Faraday cup so as to automatically determine a locus of tomographically produced Peak Power Densities and respective beam diameters as a function of respective focus coil current settings so as to provide a desired best focus condition.

The present invention provides an improved Faraday cup based feedback system and method that enables automatic quantitative optimization of beam focus conditions in an electron beam welder. Such a system and method is cost-effective and can be used rapidly and automatically to set a desired focus coil current so as to provide a best focus condition for a given application.

### BRIEF DESCRIPTION OF THE DRAWINGS

The accompanying drawings, which are incorporated into and form a part of the disclosure, illustrate an embodiment of the invention and, together with the description, serve to explain the principles of the invention.

FIG. 1 shows an example automatic focusing beam welding system for determining a best focus condition for a beam weld.

FIG. 2(a) shows a resultant data plot of Peak Power Density (W/mm²) versus focus coil current values of a defocus run.

FIG. 2(b) shows the same data of FIG. 2(a) plotted as a function of the relative machine focus setting.

### DETAILED DESCRIPTION OF THE INVENTION

Referring now to the following detailed information, and to incorporated materials; a detailed description of the invention, including specific embodiments, is presented.

Unless otherwise indicated, numbers expressing quantities of ingredients, constituents, reaction conditions and so forth used in the specification and claims are to be understood as being modified by the term “about.” Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical value, however, inherently contain certain errors necessarily resulting from the standard deviation found in their respective testing measurements.

General Description

Electron beam welds are made by first determining the “sharp focus” condition, which is used as a reference point, and then setting the welding focus above, below, or directly on this sharp focus to produce the desired weld properties. To reiterate, during focusing of, for example, an electron beam welder, the strength of the magnetic lens in the focus coils is typically manually adjusted by an operator, thus arbitrarily raising or lowering the sharp focus position in the weld chamber. The operator directs the beam onto a high melting point target material, such as, but not limited to tungsten, and adjusts the focus coil current setting while observing the intensity of the light emitted from the target so as to determine the sharp focus setting. When the emitted light reaches a maximum intensity, the beam is considered to be at sharp focus. However, producing a sharply focused beam at a given focus setting on even a single machine is not guaranteed. For example, electron beams have a degree of symmetry at a subjective sharp focus setting but such beams become substantially elliptical around a defined range on either side of the “sharp focus”. Different operators may miss the best focus condition by interpreting the brightest emission from the target material differently, resulting in different definitions of “sharp focus” and the use of beams with different properties in the welding of potentially high-value components. These difficulties are only compounded when the parameters selected for one machine are transferred to other machines. For example, the beam produced at a given focus setting on one machine may not match that produced on another, due to differences in the focusing lens and the construction of the upper column. As a result, the current density of each beam can differ, resulting in welds of differing dimensions.

The proposed concept of the present invention is directed to addressing manual adjustment subjectivity so as to produce a “sharp focus” condition in an electron beam welder. Accordingly, the present invention is based on a configured feedback system and corresponding method that includes a Faraday Cup diagnostic, more often a Modified Faraday Cup diagnostic, for automatically providing a best focus condition (i.e., a sharp focus at a predetermined position with respect to a sample of interest or a defocus position below or above the sharp focus) for circular and irregularly (e.g., elliptical) shaped electron beams.

Existing Faraday cup embodiments to provide feedback information for automatically focusing a welding chamber can be found in U.S. Pat. No. 5,468,966, by Elmer et al., entitled “System For Tomographic Determination Of The Power Distribution in Electron Beams”; U.S. Pat. No. 5,583,427, by Teruya et al., entitled “Tomographic Determination Of The Power Distribution In Electron Beams”; U.S. Pat. No. 5,554,926, by Elmer et al., entitled “Modified Faraday Cup”; U.S. Pat. No. 6,300,755, by Elmer et al., entitled “Enhanced Modified Faraday Cup For Determination Of Power Density Distribution Of Electron Beams” and pending U.S. application Ser. No. 11/158481, entitled “A trigger Probe for Determining the Orientation of an Electron Beam”, by Elmer et al.; all of which are herein incorporated by reference in its entirety.

Specific Description

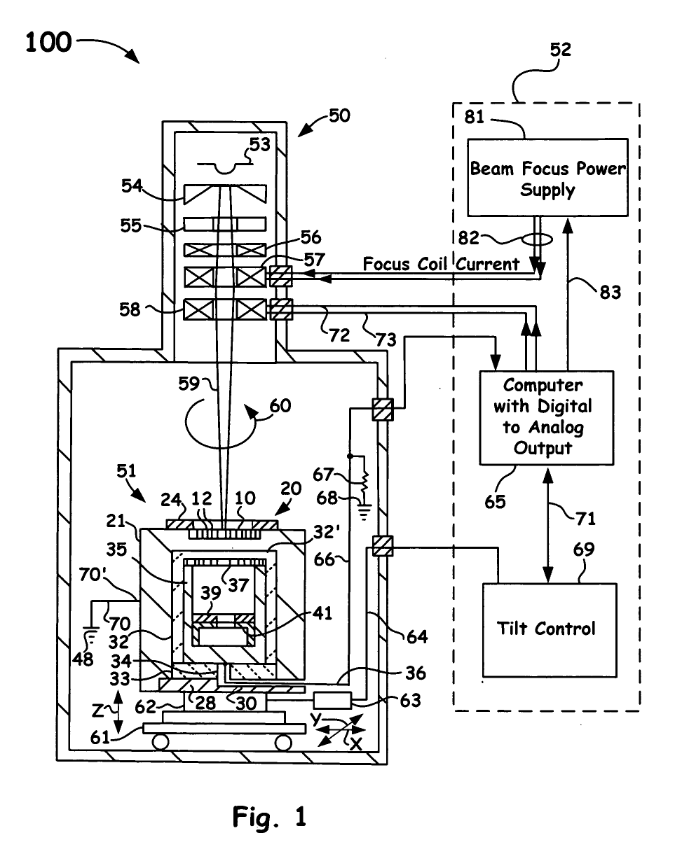

FIG. 1 illustrates an example embodiment of an automatic focusing system and is generally designated by the reference numeral 100. The system of FIG. 1 is substantially the same as that of above-incorporated by reference U.S. Pat. No. 6,300,755 and pending U.S. application Ser. No. 11/158481, entitled “A trigger Probe for Determining the Orientation of an Electron Beam”, by Elmer et al., and includes interconnected components or sub-systems, such as, for example, an electron beam gun assembly generally indicated at 50, a Faraday cup assembly, such as, a modified Faraday cup (MFC) assembly indicated by reference numeral 51, and a control and data acquisition system 52. System 52 functions to control elements of the gun assembly 50, such as a deflection coil 58 and a focusing coil 57, in addition to controlling the MFC assembly 51 and acquiring and storing the acquired tomographic profile data.

Gun assembly 50, as shown in FIG. 1, which may be used in a welding machine, often includes a filament 53, a cathode 54, an anode 55, an alignment coil 56, a magnetic lens controlled by focus coil 57, and a defection coil 58. Filament 53 may be of any desired configuration, such as a ribbon type or a hairpin type as known in the art. The various components of electron beam gun assembly 50 and details of filament 53 are known in the art. Deflection coil 58 is coupled and controlled by system 52 so as to deflect an electron beam 59 produced by gun assembly 50 in a pattern, such as, for example, an elliptical or circular pattern as indicated by arrow 60 in or order to be swept across slits 12 arranged in, for example, a Faraday cup, often an enhanced MFC 20 disposed within Faraday Cup assembly 51.

MFC 20, as shown in FIG. 1, can be mounted on a movable assembly 61, via a support member 62 and an actuator 63 connected via line 64 to a tilt controller 69 of control and data acquisition system 52. Movable assembly 61, that includes x, y, and z translation stages as denoted by the double arrows x, y, and z, provides the capability of movement of enhanced MFC 20 as desired so as to accurately align slits 12 of slit disk 10 with electron beam 59 as it moves in a pattern (e.g., a circular pattern) around disk 10.

The electrical contact 36, as shown in FIG. 1, of MFC 20 is connected via an electrical cable or lead 66 to a current viewing or sensing resistor 67 and to a common ground as indicated at 68, and to a computer 65 of system 52. As another arrangement, signal wire 36 can be replaced by a coaxial-type electrical cable and connector as detailed in above-incorporated by reference U.S. Pat. No. 6,300,755. The voltage across resistor 67 (e.g., a 100 ohm resistor) is measured and stored in computer 65 for each slit signal as beam 59 passes thereacross. Housing 21 of MFC 20, having a lower plate section 28 that includes a radially extending passageway or groove 30, is electrically connected to the common ground 48 via a cable or lead 70 connected to electrical contact 70′. Positioned within housing 21 is a liner or insulator 32 composed, for example, of Macor ceramic, alumina, and boron nitride; and an annular bottom cap or plate 33 (also composed of Macor ceramic, alumina, boron nitride, or other insulator material) having a central opening 34 which aligns with groove 30. Also located within Faraday cup 20 is a second disk 37 having a ring 39, constructed of graphite, copper, or tantalum and is often fixidly secured therein by bolts, screws, etc.

Computer 65, as shown as part of control and data acquisition system 52 of FIG. 1, is configured with digital to analog communication capabilities (e.g. via a digital to analog card) and coupled to a Beam focus power supply 81 via a predetermined cable (not shown) known to one of ordinary skill in the art (e.g., an RS 232 or USB having data transfer capability). Such a configuration enables computer 65 to supply a desired focus coil voltage setting and thus a desired focus coil current 82 to focus coil 57 via a software directed or manual command. Computer 65 is also coupled to tilt controller 69 via a cable or lead 71 and to deflection coils 58 of electron gun 50 via leads or cables 72 and 73. To accurately position the MFC 20 with respect to the sweep of the electron beam 59 across the slits 12 of disk 10, the computer 65 through tilt controller 69 enables an actuator 63 to move the movable assembly 61 in any desired direction.

It is to be appreciated that Faraday cup 20 includes a flange clamp 24 so as to secure disk 10 to the housing assembly 21. In such an arrangement, disk 10 is often constructed from tungsten, but may be constructed of tantalum, tungsten-rhenium, or other refractory metals and is configured having an odd number of radially extending slits spaced apart. As one embodiment, a predetermined slit, is arranged to have a greater width to enable orientation of a beam profile with respect to the coordinates of a welding chamber. A detailed explanation of such an example embodiment can be found in incorporated by reference U.S. Pat. No. 6,300,755.

While having a configured widened slit as detailed in U.S. Pat. No. 6,300,755 is a beneficial embodiment; such an arrangement can in some circumstances adversely affect the reconstruction of the beam, especially in cases in which the width of the widened slit is no longer small relative to the width of the beam. Therefore, the beam width of the reconstructed beam may be slightly elongated in cases of tightly focused beams as the width of the beam approaches that of an enlarged slit.

Accordingly, flange clamp 24 as another beneficial embodiment, can be modified and configured with an external electron probe to provide a fiducial locator (i.e., a timing or triggering signal) and a sensing circuit can be added to the data acquisition hardware of the present invention to detect such a fiducial locator so as to properly orient an ion or electron beam. The use of such an external electron probe eliminates the need for an enlarged slit by taking advantage of secondary and backscattered electrons generated by the interaction between the beam 59 and integrated disk 10. Such a probe rests above the slit disk and is aimed at a point located between two of the slits so that the reconstructed beam profile can be determined with the proper orientation. A detailed description of such an arrangement can be found in pending U.S. application Ser. No. 11/158481, entitled “A trigger Probe for Determining the Orientation of an Electron Beam”, by Elmer et al.; also herein incorporated by reference in its entirety.

In the method of the present invention, the strength of the magnetic lens provided by focus coil 57 is often first manually adjusted by the operator, thus arbitrarily raising or lowering the sharp focus position in the weld chamber. In order to determine an arbitrary machine “sharp focus” current setting, the operator, in manually making such an adjustment, directs the beam onto a high melting point target material, such as tungsten, and adjusts the focus coil 57 current setting while observing the intensity of the light emitted from the target. When the emitted light reaches a maximum intensity, the beam is considered to be substantially close to the desired machine sharp focus and computer 65, is utilized to generate the signals actuating the electron beam sweep, to acquire beam profile data from, for example, an MFC 20. Specifically, electron gun 50 is turned on and computer 65 is arranged to activate deflection coil 58 of electron gun 50 to move beam 59 in a predetermined pattern, e.g., circular, so as to cross each slit 12 of disk 10, and thereafter computer 65 receives the output data from a predetermined MFC 20 via lead 66 and resistor 67. The beam is then tomographically reconstructed by computer 65 from the received beam profile data and a characteristic beam spot size based on the full width half maximum (FWHM) and/or the full width at the 1/e² point of the beam (FWe²) and/or an average of a full beam diameter, can be determined based on the computed peak power density. From such an initial procedure, the resultant tomographically reconstructed beam enables the system 100 of the present invention to calculate a Peak power Density and a corresponding calculated spot size to provide a starting point for quantitatively determining a quantitative “sharp focus” current setting in addition to a locus of defocus conditions.

Computer 65, configured with data acquisition hardware, Digital to Analog (D/A) communication capabilities, and further configured with an algorithm generated out of available software, such as, but not limited to, Fortran, Basic, Visual Basic, LabView, Visual C++, C++, or any programmable language capable of operating within the scope and spirit of the invention herein, then, as one example desired embodiment, initiates auto focusing of system 100. As part of the designed logic, an incremental focus coil power supply voltage (PSV) derived about the arbitrary machine “sharp focus” current stored setting (e.g., often of about a 1 mA increment from the arbitrary machine “sharp focus” current setting and up to about 10 mA increments from the arbitrary machine “sharp focus” current setting), is computed. A converted digital to analog signal is then directed by computer 65 along communication line 83, such as an RS 232 or USB communication interface cable, to set beam focus power supply 81 to the desired voltage setting. Beam focus power supply 81 then is directed via communication line 83 to output focus coil current 82 based on the desired voltage setting to focus coil 57 so as to provide the desired focus coil increment. Next, computer 65 again generates signals actuating the electron beam sweep along lines 72 and 73, as shown in FIG. 1, to acquire beam profile data from the configured MFC 20. The beam is once again tomographically reconstructed by computer 65 from the received beam profile data and a characteristic beam spot size (e.g., FWHM) correlated to the respective focus coil current increment is then determined based on the computed peak power density. Computer 65, then increments the focus coil current and system 100 can perform the operations as disclosed above to again provide a Peak Power Density and a corresponding characteristic beam spot size for a given focus coil current increment. Such current increments and resultant spot sizes based on respective computed peak power densities are then performed for a predetermined number of times, e.g., thirty increments of about 1 mA above and below the arbitrary “best focus” setting, to provide a locus of data points so as to determine the maximum Peak Power Density and thus a non-arbitrary “sharp focus” condition. Such a procedure can often require minutes to hours, but more often requires 1-2 minutes depending on the number of desired tomographic profiles that is chosen in the automatic focusing program. Once, the non-arbitrary “sharp focus” condition is determined, a desired automatic or manual setting of the welding focus position, i.e., above, below, or directly on sharp focus, is chosen to produce desired weld properties of given materials and conditions.

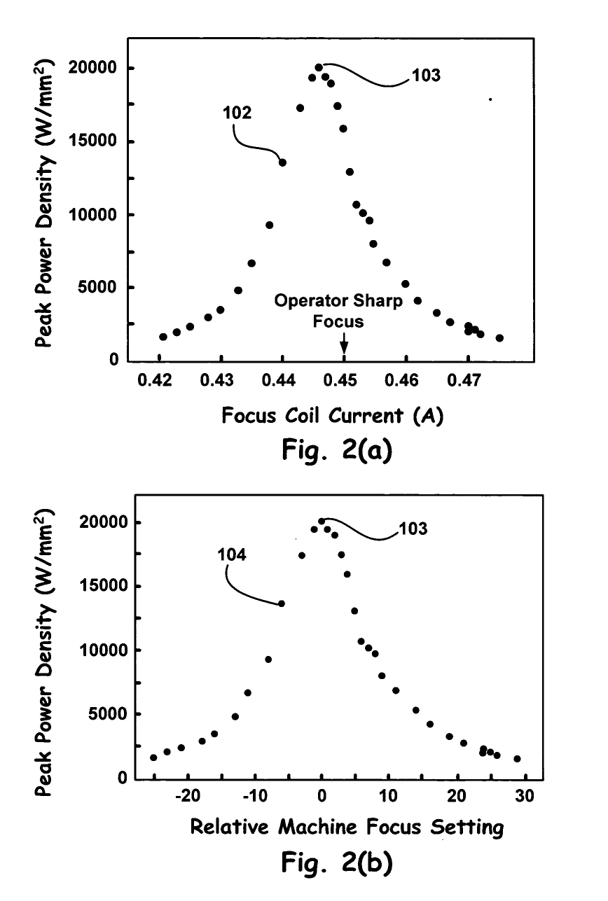

FIG. 2(a) shows a resultant data 102 plot of computed Peak Power Density (W/mm²) versus focus coil current values of a defocus run in addition to an operator determined sharp focus (denoted with an arrow and pointing to about 0.45 A) that can be determined by the automatic focusing of example system 100, as shown in FIG. 1. It is to be appreciated that such Peak Power Density (W/mm²) values, as shown in FIG. 2(a), are capable of being determined from the system of FIG. 1 by computer analyzing corresponding tomographically constructed beams so as to determine, if needed, a (FWHM) and/or (FWe²) of such resultant beams (e.g., Gaussian, elliptical, super Gaussian, semi-Gaussian, etc.) for each focus coil current setting.

FIG. 2(b) shows the same data 104 plotted as a function of the relative machine focus setting, wherein the zero value for the relative machine focus setting corresponds to the focus setting at which a maximum peak power density is measured. Since the focus coil current settings vary between welders, the method of assigning a relative machine focus setting enables users of the present invention to define a relative setting to describe the same focus condition on different welders. The machine sharp focus setting (i.e., 103, as shown in FIG. 2(b)), and a corresponding stored beam spot size based on the (FWHM) and/or (FWe²) as defined by the resultant obtained data from the automatic focusing example system 100 of FIG. 1, is used as the reference value and is set to a value of zero. Focus coil current settings above this value are given a positive value, while those below are given a negative value, as shown in the following relationship of equation (1):
Relative Machine Focus Setting=Focus Coil Current−Sharp Focus Coil Current, (1)
wherein the focus coil current (mA) is the value for each focus setting and the sharp focus coil current (mA) represents the focus coil current at the machine sharp focus setting. Accordingly, a particular machine focus setting and thus a corresponding computed beam spot size of FIG. 2(b) represents the amount of defocus above (positive) or below (negative) the sharp focus setting 103. Specifically, the focus coil current values plotted in FIG. 2(a) have been converted to the relative machine focus settings, and the results are shown in FIG. 2(b) for the same peak power density values.

The present invention thus provides an enhanced method and system that automatically generates a locus of tomographically analyzed data for determining a best focus condition (e.g., a sharp or defocused condition) for electron beam welds.

Accordingly, the present invention can be utilized with high-power, high-intensity multiple kilowatt (20 kv plus) electron beams, or with low-power (1 kv) beams in addition to analysis of ion beams. Moreover, the present invention can be utilized for the automatic analysis of any type of energy producing beams such as the generation of x-rays or use in electron beam lithography.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. An automatic method to provide a desired focus for a beam, comprising:
setting an arbitrary sharp focus coil current, providing a feedback loop so as to provide automatically, a predetermined plurality of focus coil current increments positively above and negatively below said arbitrary sharp focus coil current,
tomographically reconstructing a plurality of beams resulting from a plurality of received Faraday cup measurements, wherein each said beam correlates to a respective focus coil current;
calculating Peak Power Densities and a corresponding locus of beam diameters resulting from respective said tomographically reconstructed beams; and
determining a desired focus coil current based on said respective calculated beam diameters so as to provide a desired beam focus condition for a predetermined application.

2. The method of claim 1, wherein each of said calculated beam diameters comprises a beam diameter determined from the full width half maximum (FWHM).

3. The method of claim 1, wherein each of said calculated beam diameters comprises a beam diameter determined from the 1/e² beam width.

4. The method of claim 1, wherein said calculated Peak Power Densities comprises a maximum peak power density.

5. The method of claim 4, wherein said Peak Power Densities are correlated to one or more respective relative machine focus settings so as to enable similar apparatus to utilize correlated stored foil current values.

6. The methods of claim 1, wherein said desired beam focus condition can be selected by an operator or automatically via software.

7. The method of claim 1, wherein said feedback loop further comprises a central computer, wherein said central computer comprises an algorithm to enable an iteration of: receiving a profile data set for a predetermined focus coil current from a Modified Faraday Cup, generating a communication signal so as to direct a desired focus coil current increment, and sweeping a resultant beam across a plurality of slits configured in said Modified Faraday Cup to tomographically produce said desired focus coil current increment.

8. A method for providing a desired beam focus condition for an electron beam welder, comprising:
(a) setting a predetermined focus coil current;
(b) sweeping a beam across a disk having a plurality of slits, said disk being arranged in a Faraday cup system,
(c) positioning a probe to detect secondary and backscattered electrons from a predetermined position on said disk;
(d) sensing a signal produced by said probe;
(e) calculating the proper orientation of said beam based on said signal so as to produce a set of beam profile data; and
(f) processing said beam profile data so as to tomographically reconstruct the power distribution in said beam;
(g) calculating a beam diameter resulting from said tomographically reconstructed beam;
(h) providing a predetermined incremental focus coil current;
(i) iterating steps (b) through (h) until a desired locus of Peak Power Densities and beam diameters are computed; and
setting a desired focus coil current based on said calculated beam diameters to provide a desired beam focus condition for a given application.

9. The method of claim 8, wherein each of said calculated beam diameters comprises a beam diameter determined from the full width half maximum (FWHM).

10. The method of claim 8, wherein each of said calculated beam diameters comprises a beam diameter determined from the 1/e² beam width.

11. The method of claim 8, wherein said calculated Peak Power Densities comprises a maximum peak power density.

12. The method of claim 11, wherein said Peak Power Densities are correlated to one or more respective relative machine focus settings so as to enable similar apparatus to utilize correlated stored focus foil current values.

13. The methods of claim 8, wherein said desired beam focus condition can be selected by an operator or automatically via software.

14. The method of claim 8, wherein said feedback loop further comprises a central computer, wherein said central computer comprises an algorithm to enable an iteration of: receiving a profile data set for a predetermined focus coil current from a Modified Faraday Cup, generating a communication signal to so as to direct a desired focus coil current increment, and sweeping a resultant beam across a plurality of slits configured in said Modified Faraday Cup to tomographically produce said desired focus coil current increment.

15. The method of claim 8, wherein said secondary and backscattered electrons are detected via a predetermined field of view.

16. The method of claim 8, wherein said sensing step further comprises an electronic sensing circuit integrated into a data acquisition hardware arrangement.

17. The method of claim 16, wherein said electronic sensing circuit can be arranged internal or external of said Faraday cup system to allow a single feedthrough.

18. A system to provide a desired focus for a beam, comprising:
a Faraday cup,
feedback loop means coupled to said Faraday cup arranged to receive and collect data so as to automatically determine a locus of tomographically produced Peak Power Densities and respective beam diameters as a function of respective focus coil current settings, wherein said feedback loop means as a function of said locus of tomographically produced Peak Power Densities and respective beam diameters can set a desired best focus.

19. The system of claim 18, wherein each of said beam diameters comprises a beam diameter determined from the full width half maximum (FWHM).

20. The system of claim 18, wherein each of said beam diameters comprises a beam diameter determined from the 1/e² beam width.

21. The system of claim 18, wherein said Peak Power Densities comprises a maximum peak power.

22. The system of claim 18, wherein said Peak Power Densities are correlated to one or more respective relative machine focus settings so as to enable similar apparatus to utilize correlated stored focus foil current values.

23. The system of claim 18, wherein said desired best focus can be selected by an operator or automatically via software.

24. The system of claim 18, wherein said feedback loop means further comprises a central computer, wherein said central computer comprises an algorithm to generate a profile data set for a predetermined focus coil current from said Faraday Cup and wherein said central computer can thereafter generate a communication signal so as to generate one or more desired focus coil current increments, and wherein said central computer can thereafter sweep a resultant beam based on said one or more desired focus coil current increments across a disk having a plurality of radially extending slits configured in said Faraday Cup so as to tomographically produce respective one or more resultant beams.

25. The system of claim 24, wherein said Faraday cup comprises a Modified Faraday Cup.

26. The system of claim 24, wherein said disk configured in said Modified Faraday cup further comprises a refractory metal, wherein at least one of said radially extending slits is configured with a width greater than the width of the other radially extending slits so as to provide a desired signal for proper orientation of a swept beam.

27. The system of claim 24, wherein said disk configured in said Modified Faraday cup further comprises a refractory metal, wherein said radially extending slits are substantially of equal width, and wherein said Modified Faraday cup further comprises a fixidly arranged probe above said disk to capture a plurality of electrons so as to provide a desired signal for proper orientation of a swept beam.
